(19) United States
(12) Patent Application Publication
(10) Pub. No.: US 2009/0160977 A1
(43) Pub. Date: Jun. 25, 2009

(54) SYSTEM FOR MULTI-MEDIA IMAGE MAGNIFICATION

(76) Inventors: Timothy M. Curtin, West Lafayette, IN (US); Michael J. Roberts, West Lafayette, IN (US)

Correspondence Address: BOSE MCKINNEY & EVANS LLP, 111 MONUMENT CIRCLE, SUITE 2700, INDIANAPOLIS, IN, 46204, US

(21) Appl. No.: 12/272,327

(22) Filed: Nov. 17, 2008

Related U.S. Application Data
(60) Provisional application No. 60/988,265, filed on Nov. 15, 2007.

(51) Int. Cl. H04N 5/262

(52) U.S. Cl. 348/240.99; 348/E05.055

(57) ABSTRACT

A vision magnification system includes a fixed work area, a camera, and drive mechanism capable of moving the camera in at least one direction. The vision magnification system provides a magnified image of an object for viewing by a user and is particularly useful for individuals having impaired vision. A control device includes a pointing device, to control movement of the camera in a direction provided by the user, and a tracking device, which can be coupled to a writing instrument to control movement of the camera when the user uses the writing instrument.

### RELATED APPLICATIONS

The present invention claims priority to the U.S. Provisional Patent Application Ser. No. 60/988,265 filed Nov. 15, 2007, the entirety of which is incorporated herein by reference.

### FIELD OF THE INVENTION

The present invention generally relates to an image magnification system, more particularly to an image magnification system for a visually impaired person.

### BACKGROUND

Image magnification systems are used to magnify a variety of objects. An example is a system used for magnifying images of a working area with an object resting on the working area, where the object is too small to view for persons with normal vision. Another example is a system for magnifying images of written material for visually impaired persons.

Currently, image magnification systems for visually impaired persons can include a stationary color camera and a working area moveable in two dimensions. The camera is positioned to receive images either directly from a targeted viewing area or as reflected from a mirror having an angular position of approximately 45° relative to the viewing area. Magnified images can be displayed on display devices including Cathode Ray Tubes or Liquid Crystal Display monitors. Depending on the level of magnification, ratios of the working area to the displayed image can vary from, 1:1, i.e., target working area having the same dimensions as that which is displayed, to a maximum magnification ratio.

Users of current image magnification systems manually maneuver the working platform in two dimensions. For example, a flat area upon which an object, e.g., written material, is placed is moved in the X-Y directions in order to bring the working platform into the camera's focus. Currently, in order to accommodate objects of different sizes, the footprint required for complete movement range of the working platform is excessively large and the movement of the platform is cumbersome.

Prior art system users move the working platform from a central location to upper-left, lower-left, upper right, and lower right quadrants. Therefore, the movement of the working platform spans an area that may be four times the area of the working platform. Therefore, the user must allow for a large workspace. This is shown in FIG. 1, depicting the current state of the prior art.

Maneuvering of the working area can be cumbersome. For example, in order to read written material placed on a working platform, the user moves the platform generally in the “X” direction, i.e., horizontally, along the direction of the written text. When the user reaches the end of a line, the user moves the platform both in the “X” direction and the “Y” direction, i.e., vertically, to reach the beginning of a new line. Such movements of the platform can create multiple sources of frustration for the user. First, depending on the image magnification level, the camera may receive images from only a small portion (“image envelope”) of the platform. Depending on the size of the image envelope, the user may overshoot the target area as the user is moving from one line to another line. Further, if the written text placed on a working area has excessively large font size, individual letters of the text may not fit within an image envelope of the camera. Consequently, the corresponding displayed image may not display portions of the selected text. Additionally, users can suffer from “motion sickness” due to sudden movements of the work area which can cause dizziness, fatigue, and nausea. Motion sickness, also known as kinetosis, can be caused when visual images become inconsistent with motion perceived by the inner ear's equilibrium/balance system. The motion sickness is further worsened when the user selects higher magnification levels where relative motion is more erratic. Additionally, moving the platform can cause poor posture and excessive restrictions which place undesirable stress on the user's neck, shoulders, elbows and hands.

In addition to magnification adjustments, users may need to adjust other aspects of the image for improved visibility. For example, a user may need to adjust the color contrast of the viewed image as the user is viewing different parts of the image. This may occur if a portion of a printed image requires a higher color or grayscale contrast as compared to neighboring area having written text. In current systems, in addition to moving the platform the user must also adjust the image controls including magnification, color contrast, brightness, focus settings, and other well known image adjustments. These adjustments require stopping moving the platform and make the necessary adjustments. Such interruptions create additional inefficiencies.

Additionally, image magnification systems are used to display images of a user writing text in the working area. Currently, the user manually moves the working area in a leftward direction while writing with a writing instrument. The leftward motion is necessary to maintain the activity in the focus field of the camera. The combination of moving the working area at the same time as writing requires a time consuming learning phase. In addition, many who are visually impaired also have other physical impairments. Therefore, a user of the prior art system may be physically unable to move the working area with one arm while writing with the other.

Further, in current systems when the user reaches the end of a line while writing the user has to move the working area vertically to the next line while moving the working area to the right to reach the beginning of the next line. These required manual movements of the working area while viewing images of the user writing can be cumbersome. This is especially true when the user wishes to draw an object which requires movement of a writing instrument in two dimensions while moving the working area, also in two dimensions. The working area has to be moved substantially in the opposite direction to the movement of the writing instrument. Further, if the user desires to make adjustments to magnification, contrast or other adjustable settings, the user must stop writing and make the desired adjustments. This also creates inefficiencies as well as inconveniences. Also, for persons with multiple impairments near simultaneous manipulation of the work area and performing other tasks, e.g., contrast adjustment, can be cumbersome to nearly impossible.

Furthermore, in certain settings, e.g., classroom, users of image magnification systems often need to view images from multiple sources. In a lecture setting, a visually impaired student needs to simultaneously view the written material in a textbook while viewing the material the instructor is projecting on to a classroom screen. Currently, some image magnification systems accept auxiliary inputs, e.g., S-video or composite video, or provide an output of the image magnification system for a computer. However, magnified images and auxiliary material are displayed on split screens which detrimentally and substantially reduce the size of the displayed work area.

Current image magnification systems lack effective methods and hardware to update firmware installed on the image magnification system. Further, when the image magnification system is not operating properly, diagnosing and repairing hardware malfunctions can require multiple visits by a technician to the system. A case study conducted to study the level of satisfaction of users of the prior art systems confirmed substantially all of the above stated shortcomings. The users in the case study confirmed their frustrations and indicated a long felt need for improvements.

### SUMMARY OF INVENTION

In accordance with one aspect of the present invention there is provided a vision magnification system to provide a magnified image of an object for viewing by a user. The system includes a fixed work area, to support the object, a camera, to provide an image of at least a portion the object, a camera movement control system taking inputs from the user and thereby controlling the movement of the first camera, and a drive system, coupled to the camera, to move the camera in at least one direction.

In accordance with another aspect of the present invention there is provided a vision magnification system having a camera to provide an image of an object for viewing by a user, a monitor displaying an image of at least part of the object, a drive system, coupled to the camera, to move the camera in a first direction and a second direction, a processor, coupled to the drive system, to control movement of the first camera, and a control device, coupled to the processor, wherein the control device communicates with the processor and thereby controls the movement of the first camera in the first and second directions.

### BRIEF DESCRIPTION OF DRAWINGS

The above-mentioned and other advantages of the present invention and the manner of obtaining them, will become more apparent and the invention itself will be better understood by reference to the following description of the embodiments of the invention taken in conjunction with the accompanying drawings, wherein:

FIG. 1 is a perspective view of the prior art;

FIG. 2 is a perspective view of one embodiment of the vision magnification system in accordance with the present teachings;

FIG. 3 is another perspective view of the embodiment shown in FIG. 2 in accordance with the present teachings;

FIG. 4 is a perspective view of another embodiment of the vision magnification system in accordance with the present teachings;

FIG. 5 is a plan view of the embodiment shown in FIG. 4 in accordance with the present teachings;

FIG. 6 is a top view of the embodiment shown in FIG. 4 in accordance with the present teachings;

FIG. 7 is a perspective view of a pen tracker in accordance with the present teachings;

FIG. 8 is a partial perspective view of circuit housing containing camera, control boards, and photo-diode in accordance with the present teachings;

FIG. 9 is a diagrammatic view of an infrared pick-up camera with a wide angle lens and an infrared filter in accordance with the present teachings;

FIG. 10a is a schematic view of interaction of certain hardware blocks in accordance with the present teachings;

FIG. 10b is a schematic view of interaction of additional hardware blocks in accordance with the present teachings; and

FIG. 11 is a schematic view of interactions of certain software blocks in accordance with the present invention.

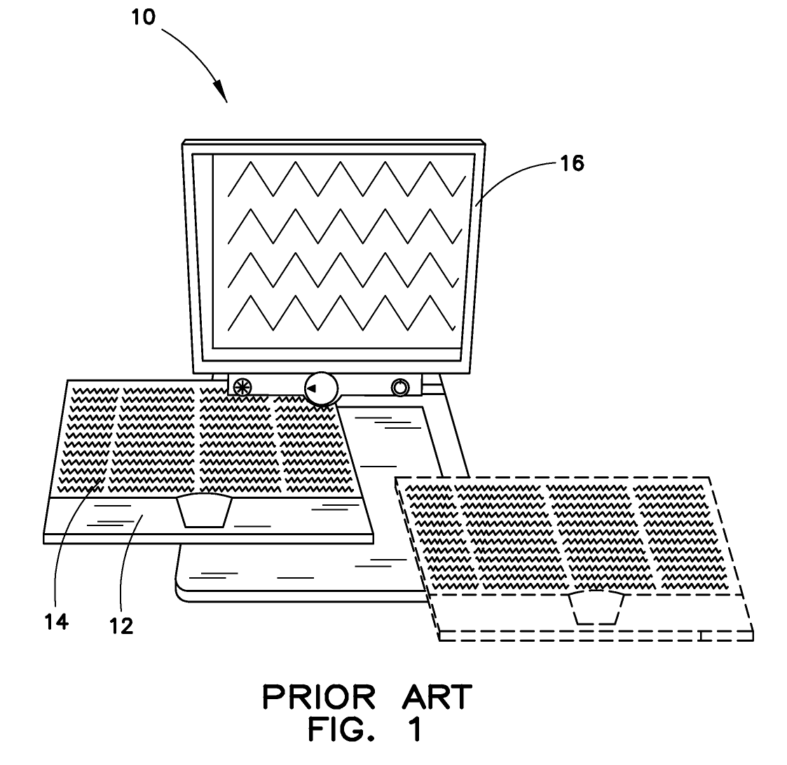

### DETAILED DESCRIPTION

The embodiments in accordance with the present teachings described below are not intended to be exhaustive or to limit the present teachings to the precise forms disclosed in the following detailed description. Rather, the embodiments are chosen and described so that others skilled in the art may appreciate and understand the principles and practices of the present teachings.

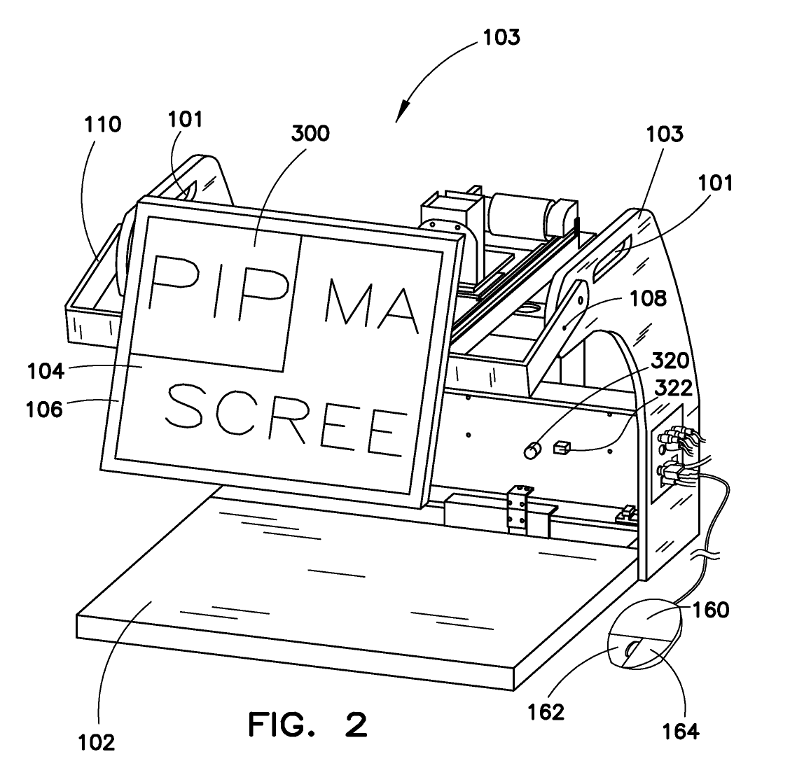

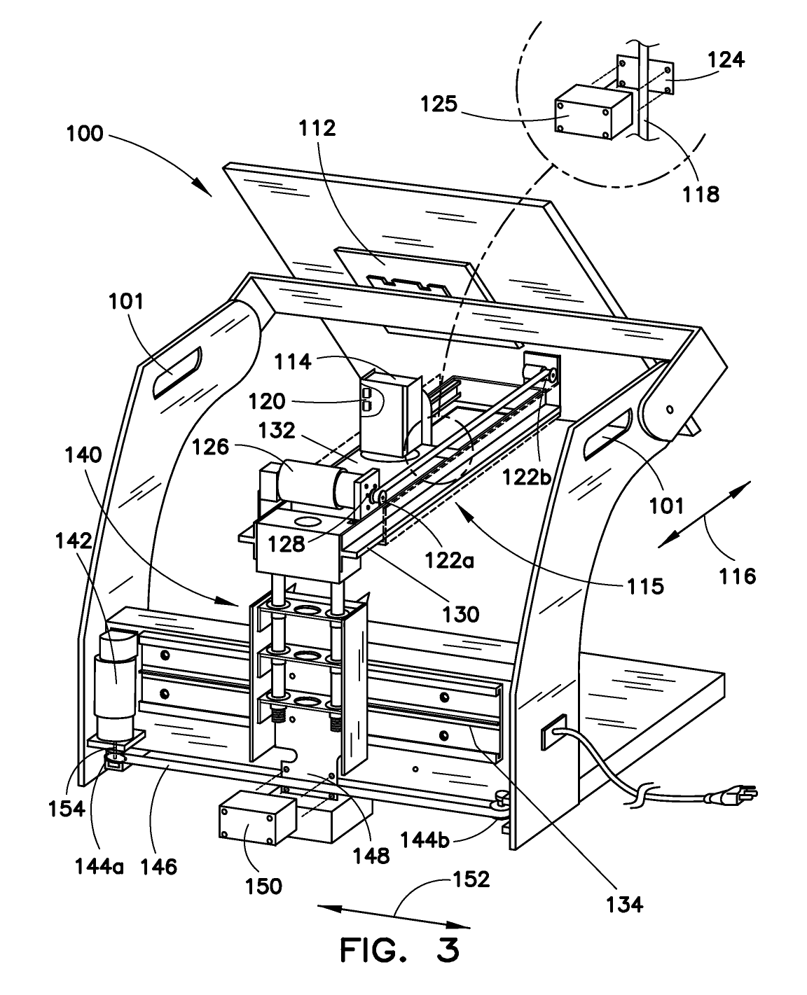

Referring to FIGS. 2-3, perspective views of the vision magnification system 100 according to the present teachings are shown. Lifting handles are formed by cutouts 101 in L-shaped supports 103. A stationary work area 102 supports objects (not shown). A magnified image 104 is shown on monitor 106 by electronic circuitry 120. The monitor 106 is held by monitor bracket arms 108 coupled to supports 103 which allows the monitor to be tilted upward and downward about a pivot arm 110 defined by the length of monitor bracket arms 108. It is envisioned that the object 14 is either affixed to the stationary work area 102 by a depression in the surface of work area 102, designed to hold in place the object, or by using vacuum or other means known to those skilled in the art. The object may also rest on work area 102 in a loose manner and free to move by the user. The monitor 106 is attached to the monitor bracket arms 108 by monitor bracket 112.

A Y-direction motion subassembly 115 is shown in FIGS. 2 and 3. The Y-belt 118 is wound around two Y- pulleys 122a and 122b. The Y-belt 118 is coupled to the Y-bracket 124 and the Y-attachment block 125, so that movement of the Y-belt 118 forces movement of the Y-bracket 124 and the Y-attachment block 125. Circuitry housing 114 is attached to Y-bracket 124, and therefore is movable in the Y direction 116 as shown in FIG. 3 by Y-belt 118. The circuitry housing is placed on the Y-platform 132. The Y-platform moves along Y-rails 130. The circuitry housing 114 contains circuitry 120 and other hardware such as a processor, a main camera, an infrared filter, a wide angle lens, an infrared pick-up camera, and a photo-diode. These components will be described in greater detail below. Y-bracket 124 and Y-attachment block 125 are in turn coupled to circuitry housing 114, thereby, movement of Y-belt 118 translates to movement of the circuitry housing 114 in the Y-direction 116. Because of the connectivity between Y-belt 118 and the circuitry housing 114, the main camera, the IR pick-up camera, and the photo-diode move in the Y-direction 116 as Y-belt 118 moves in the Y-direction 116. The Y-Pulley 122a is coupled to Y-motor 126. Activation of Y-motor 126 causes Y-motor shaft 128 which turns Y-pulley 122a. Rotation of Y-pulley 122a causes Y-belt 118 to move in the Y-direction 116. This result is obtained because the Y-belt 118 is tightly wound between Y-pulleys 122a and 122b. To reduce the chance of the Y-belt slipping on the Y-pulleys, the Y-belt 118 may have teeth or ribs which could interface with geared surfaces of the Y-pulleys.

The Y-motor 126 can be a direct current, alternating current, or stepper motor. In a direct current (DC) or alternating current (AC) implementation, a Y-motor control circuitry activates and deactivates the Y-motor 126 by either a feedback or feedforward-only implementation. In the feedback implementation a Y-motor optical reference wheel (not shown) is utilized to determine the exact rotational position of the Y-motor 126 with a fine resolution. Other reference locators, such as hall-effect sensors and variable reluctance sensors, known to those skilled in the art may be utilized in order to determine the precise rotational position of the motor. A Y-motor encoder (not shown) may be utilized to receive an encoded signal from the circuitry 120. For example in DC or AC feedback implementation of the Y-motor 126, the circuitry 120 sends a string of bits to the Y-motor encoder, requesting a certain amount of rotation by the Y-motor 126. The Y-motor encoder has a sufficiently fine resolution to achieve small rotational movements. The Y-motor control circuitry utilizes the information received from the Y-motor optical reference wheel as a feedback signal to determine how long to activate the Y-motor 126 for the desired amount of rotation as requested by the Y-motor encoder. Therefore, to achieve a desired rotational position spaced away from the current position of Y-motor shaft 128, Y-motor 126 is activated. When the desired rotational position has been reached, in accordance with the Y-motor optical reference wheel, Y-motor 126 is deactivated.

A motor brake (not shown) can be used in conjunction with the Y-motor 126 acting on the Y-motor shaft 128, as commonly used by those skilled in the art. The motor brake can be magnetic acting on the Y-motor shaft 128 or a shoe-type brake that mechanically grips the Y-motor shaft 128 to quickly stop the rotation of the shaft. Other types of brake known to those skilled in the art may also be used to stop the rotation of the motor. The purpose of the motor brake is to stop the motor from turning when the desired rotational location has been achieved, and to avoid overshooting the desired location due to the angular momentum of the motor. Alternatively, in a feedback-implementation, the lack of a motor brake can be overcome by reversing the motor in the event of overshooting. Furthermore, in a brakeless feedback implementation, due to the presence of a feedback signal indicating the exact location of the motor, the circuitry 120 can also use a lookup table to schedule a certain amount of rotation by the Y-motor 126. The feedback signal from the Y-motor optical reference wheel can be used to calibrate the look-up table on an ongoing basis. Furthermore, to prevent overshooting the desired rotational position, the Y-motor can be deactivated prematurely and reactivated in increments to arrive at the desired rotational position.

Alternatively, a feedforward-only implementation may be utilized without using the Y-motor optical reference wheel. In this implementation, the Y-motor encoder analyzes the string of bits sent from the circuitry 120 and based on a look-up table activates the Y-motor 126 for a certain amount of time. This feedforward-only implementation can be used with a motor brake for added accuracy. Alternatively, the motor brake can be avoided all together in either the feedback or feedforward-only implementations, described above, by utilizing the drag on the motor caused by the moving parts to slow and stop the motor once the motor has been deactivated. A feedforward-only implementation may require periodic calibration of the Y-motor control circuitry as the vision magnification system 100 is used over a period of time, since the wear on the system will require altering the values in the look-up table. This calibration may be done as the Vision magnification system 100 is first turned on and the calibration performed once per power cycle. Alternatively, a stepper motor can be used in place of a DC or AC motor as the Y-motor 126. Stepper motors are more accurate and can accept digital data for the desired rotation. The stepper motor can be used in either a feedback or feedforward-only implementations. In the feedforward-only implementation, as described above, the stepper motor may have to be calibrated occasionally, e.g., once per power cycle. In a feedback implementation the calibration can occur on an ongoing basis, as described above.

The description of mechanisms and choices for components provided above for the Y-direction motion subassembly 115 can be applied to an X-direction motion subassembly 140. The X-direction motion subassembly 140, which is similar to the Y-direction motion subassembly 115, is shown in FIGS. 2-3. The X-belt 146 is wound around two X-pulleys 144a and 144b. The X-belt 146 is coupled to the X-bracket 148 and the X-attachment block 150, so that movement of the X-belt 146 forces movement of the X-bracket 148 and the X-attachment block 150. Y-direction motion subassembly 115 is attached to X-bracket 124, and therefore Y-direction motion subassembly 115 is movable in the X-direction 152 as shown in FIG. 3 by X-belt 146. The circuitry housing 114 is coupled to X-direction motion subassembly 140. Because of the connectivity between X-belt 146 and the circuitry housing 114, the main camera, the IR pick-up camera, and the photo-diode move in the X-direction 152 as X-belt 146 moves in the X-direction 152. That is, X-bracket 148 and X-attachment block 150 are coupled to circuitry housing 114, thereby, movement of X-belt 146 translates to movement of the circuitry housing 114 in the X-direction 152. The X-Pulley 144a is coupled to X-motor 142. Activation of X-motor 142 causes X-motor shaft 154 to turn X-pulley 144a. Rotation of X-pulley 144a causes X-belt 146 to move in the X-direction 152. This result is obtained because the X-belt 146 is tightly wound between X-pulleys 144a and 144b. To reduce the chance of the X-belt slipping on the X-pulleys, the X-belt 146 may have teeth or ribs which could interface with geared surfaces of the X-pulleys.

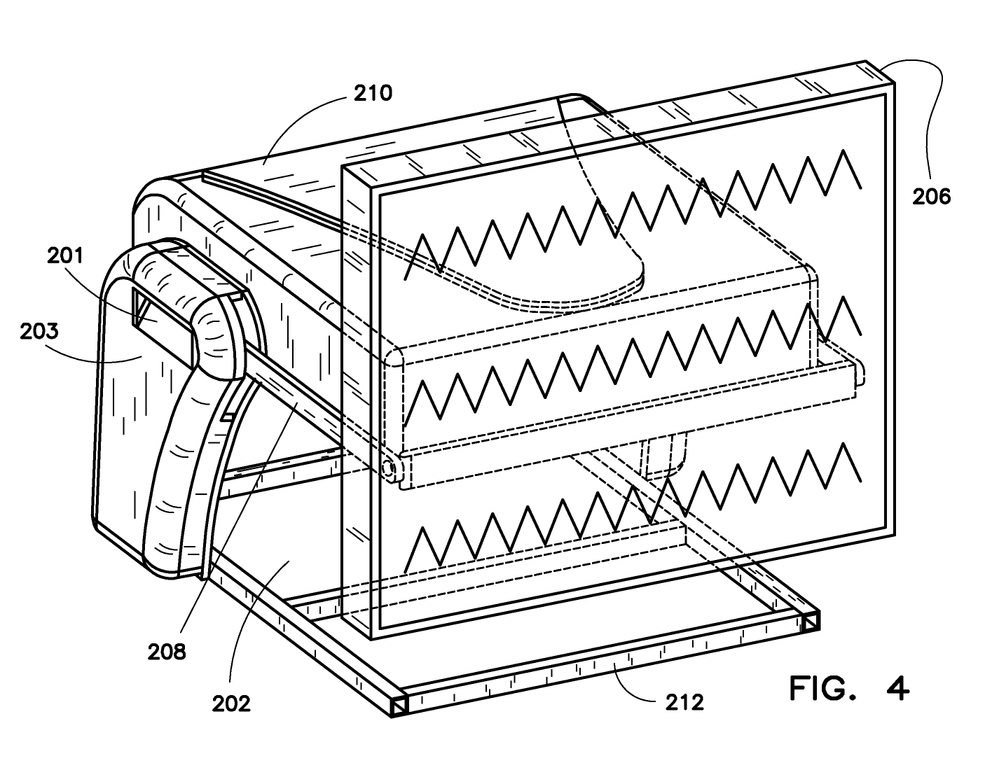

The above examples of motor technology coupled to pulleys and a belt are only provided for reference. Other implementations such as solid linkages using cams and/or pivot arms are known to those skilled in the art. Referring to FIGS. 4-6, a different embodiment using screws and guide rods are shown in place of belts and pulleys. Although belts and pulleys have the advantage of being light weight and relatively inexpensive, these are also accompanied with certain disadvantages. Since the main camera moves as the Y-motor and X-motor are activated in the Y-direction and X-direction, any looseness in the Y-belt or the X-belt, or any play between the belts and pulleys result in sudden movements of the camera. The magnified image 104 displayed on monitor 106 further emphasizes the sudden movement of the camera. Further as the belts age they become loose. Thereby, the sudden movements can worsen. These sudden movements can result in a feeling of nausea and discomfort. This can be of particular concern since during the course of a session where the magnification system is being used the user may stop and restart the camera motion many times. Using screws and guide rods can alleviate the problem of sudden movements. However, screws and guide rods are heavier and more costly to implement.

Referring to FIG. 4, a second embodiment of the image magnification system is shown. In this embodiment, work area 202 is placed under main camera. Work area 202 has well areas within which object to be magnified can be placed. Monitor 206 is attached to monitor arms 208. Hood 210 covers Y-direction motion and X-direction motion subassemblies, described below. In side panels 203, recesses 201 are provided to assist in lifting the image magnification system. Frame extender 212 is provided to enhance stability of the image magnification system.

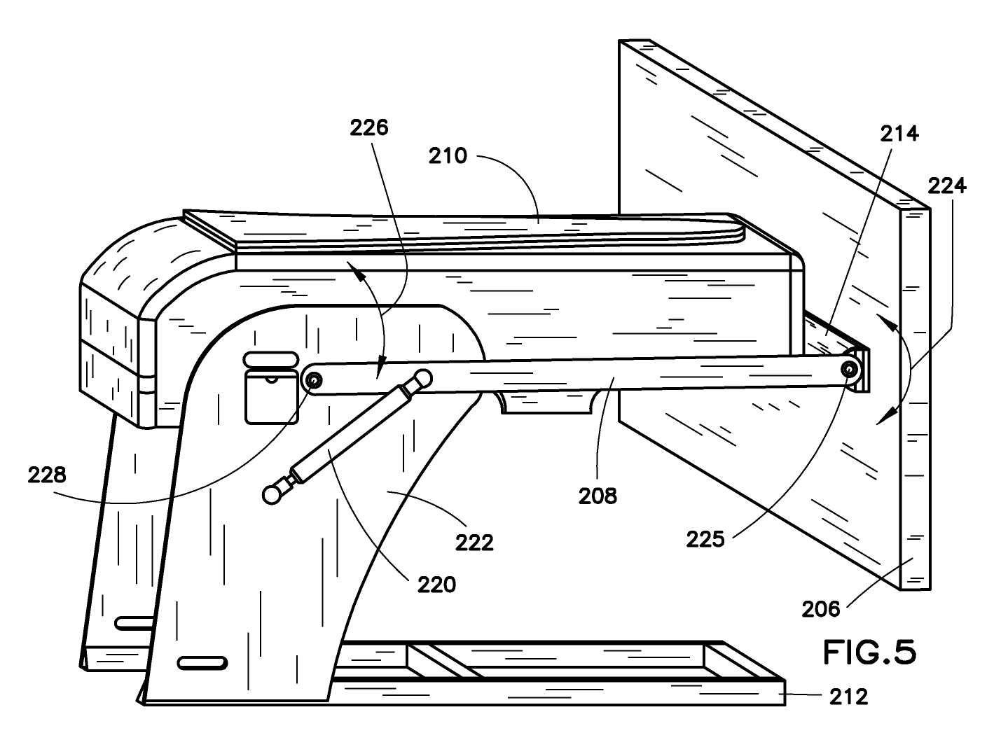

Referring to FIG. 5, a side view of the embodiment shown in FIG. 4 is provided. Side panel 203 is removed to reveal air shock 220 coupled between monitor arm 208 and side support 222. Two different types of tilting action are possible with the embodiment shown in FIG. 5. The first tilting action is designated by reference numeral 224, and is used to position monitor 206 for better viewing. Hinges 225 coupled between monitor arms 208 and monitor bracket 214 allow monitor 206 to tilt in the manner specified by arrow 224. Tightening features (not shown) can be added to hinges 225 to allow monitor 206 to retain its tilted position. The second type of tilting is according to arrow 226. The user may often need to tilt the monitor over the image magnification system in order to access the object placed in the work area 202. Monitor arms 208 are coupled to side supports 222 by way of hinges 228. Monitor 206 is allowed to tilt according to arrow 226 about hinges 228. Tightening features (not shown) can be added to hinges 228 to allow monitor 206 to retain its tilted position. Two air shocks 220 are provided, one on each side of the image magnification system. Air shocks 220 are provided to create a smooth tilting action for monitor 206. The angular position of air shocks 220 defines the arc of monitor 206 as it is being titled.

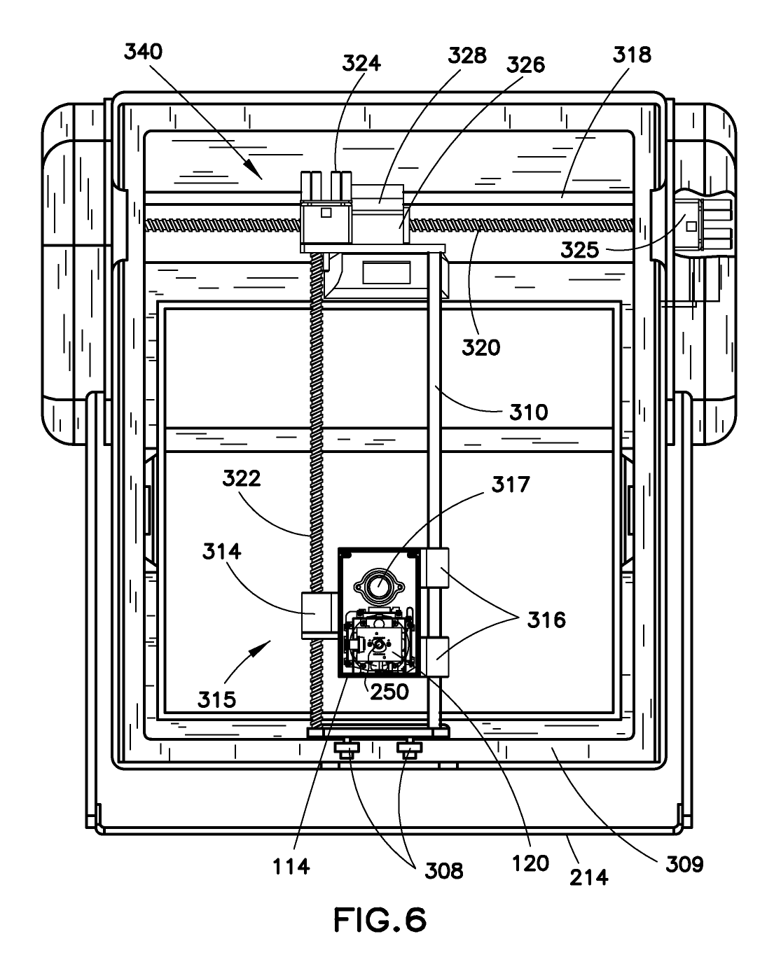

Referring to FIG. 6, X-direction motion subassembly 340 and Y-direction motion subassembly 315 are shown. In the embodiment shown in FIG. 6, screws and guide rods are used to eliminate the disadvantages of timing belts and pulley as discussed above. Two motors 324 and 325 cause movement of Y-direction motion subassembly 315 and X-direction motion subassembly 340, respectively. Motors 324 and 325 can be stepper motors, DC motors, or AC motors as is well known in the art. Activation of motor 324 causes screw 322 to turn. Screw 322 is in the form of an “all-thread” which is an elongated screw terminated between motor and Y-termination bracket 311.

In connection with Y-direction motion subassembly 315, nut 314 engages screw 322 and causes circuitry housing 114 to move along the length of screw 322. In one implementation an anti-backlash nut is used for nut 314 in order to further reduce initial sudden movement of circuitry housing 114. Y-screw 322 coupled with nut 314 provides support for circuitry housing 114 on one side while guide rod 310 and guide rod bearings 316 provide support on the other side. As Y-screw 322 turns, nut 314 moves circuitry housing 114 along the length of screw 322. In order to prevent a cantilever effect, rollers 308 disposed on track 309 are provided. The cantilever effect causes circuitry housing 114 to move suddenly upon activation and deactivation of motor 324. These sudden movements create undesirable jolt-like movement of the image on monitor 206.

X-direction motion subassembly 340 is composed of motor 325 (shown in break-away view), screw 320, guide rod 318, nut 326 and guide rod bearing 328. Screw 320 is in the form of an “all-thread” which is an elongated screw terminated between motor and X-termination bracket (not shown). Nut 326 can be an anti-backlash nut to reduce sudden movements as motor 325 is activated and deactivated. Screw 320 and guide rod shaft are positioned such that torque generated on screw 320 by motor 325 and thereby translated to Y-direction motion subassembly 315 is minimized.

The circuitry housing includes several main components. Main camera 250 is shown through a cutout of circuit 120. Infrared camera fitting 317 is shown next to circuitry housing 120. Infrared camera fitting 317 receives an infrared filter, a wide angle lens and an infrared camera. These components and their interrelationship are further described below.

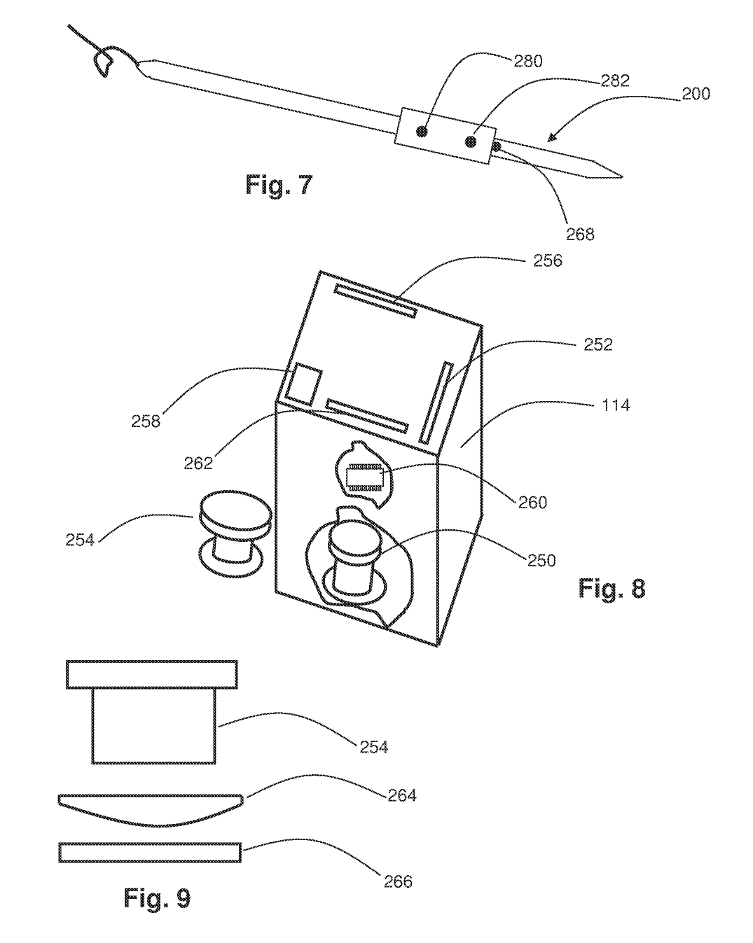

In both of the above embodiments, X-direction motion subassemblies 140 and 340 and Y-direction motion subassemblies 115 and 315 cause circuitry housing 114 to move in X-direction 152 (or along the length of screw 320) and Y-direction 116 (or along the length of screw 322), respectively. The movement of circuitry housing 114 is controlled by either movement of a control device, such an electronic pointing device 160 (shown in FIG. 2) or by movement of a tracking device or a writing device 200 (shown in FIG. 7). The pointing device 160 according to the present teachings can be a mouse including a three button optical mouse, or preferably a five button optical mouse. The buttons 162 and wheel 164 on the pointing device 160 are used to affect a variety of adjustments, e.g., contrast, selection of written text, magnification, lighting, triggering on-screen display menu (hereinafter OSD), and a series of other auxiliary functions that are programmable by virtue of activation of a combination of the buttons 162 and the wheel 164. A light switch 322 (shown in FIG. 2) is provided to turn lights pointing to the work area on and off. In one embodiment light emitting diodes (LED) can be used. Also, in one embodiment, photo diodes can be placed near the work area to receive light reflected from the work area. As the intensity of reflected light decreases, the intensity of the light from the source, e.g., LEDs, can be increased to maintain a consistent brightness on the work area. These photo diodes can be part of a feedback system designed to maintain a target brightness on the work area. Shadows can be caused by a variety of objects, e.g., user's hands. Presence of shadows can be both distracting to the user as well as the tracking system, described below. In another embodiment, the intensity of the lights is controlled by the OSD. Other auxiliary functions may include brightness of the magnified image 104, focus options, e.g., manual focus or autofocus, and other camera and image related options known to those skilled in the art. The pointing device 160 can be tethered or wireless. The wireless implementation of the pointing device 160 can be achieved by broadcasting infrared (IR), or radio frequency (RF) signals from the device. The pointing device 160 can communicate via any of the popular platforms, which are well known to those skilled in the art, such as PS2 and USB.

As mentioned above, the circuitry housing 114 contains circuitry 120 and other hardware such as main camera 250, IR pick-up camera 254, and photo-diode 258, as shown in FIG. 8. The circuitry 120 contains a main camera control circuit 252, an IR pick-up camera control circuit 256, and a processor board 262 containing at least one processor 260. The main camera 250 is pointed downward to the stationary work area 102. The processor 260 communicates with the main camera control circuit 256 to control functionality of the camera. These functions include, zooming, contrast adjustment, color/grayscale adjustment, and other image adjustments known to those skilled in the art. These adjustments can be achieved by populating respective registers with digital data. For example, an eight bit register dedicated for the zooming function can be populated with a value of 00000000 to 11111111 for zooming adjustments of zero to maximum zooming capabilities, respectively. Therefore, the adjustments on the electronic point device 160 are relayed to registers of the main camera control circuit 252 by processor 260. For example, as the user makes adjustment on the electronic pointing device 160 by, e.g., pressing button 162 and turning wheel 164, the processor 260 recognizes these adjustments by interpreting the digital signals emanating from the electronic pointing device 160. Once the desired adjustment is determined, the processor 260 mounted by processor board 262 programs the registers of the main camera control circuit 252 with the appropriate values.

Other methods for communicating with the main camera control circuit 252 are also available to control various functionalities of the main camera 250. These include obtaining digital data from the electronic pointing device 160 and translating that to an analog signal by the use of a digital-to-analog converter which is then used to adjust various features of the main camera 250. Also, the electronic pointing device 160 could be providing analog data which can be conditioned by the processor board 262 by operational amplifiers, and thereby fed to main camera 250 for adjusting various features. Alternatively, analog signals from the electronic pointing device 160 can be read in by the processor 260 via analog to digital ports, and either directly used to populate registers of the main camera control circuit 252 or by outputting analog signals on digital-to-analog converters to operational amplifiers for conditioning prior to routing to the main camera control circuit for adjusting various features. Other combinations of relaying information from the electronic pointing device 160 to the main camera 250 to control various features of the main camera 250, which are known to those skilled in the art, are also available.

As mentioned above the electronic pointing device 160 can be a three-button or a five-button optical mouse. Other types of pointing devices such as a trackball, a wheeled mouse, or a touchpad can also be used. Alternatively, other electronic pointing devices equipped with, e.g., a laser pointing device or a light emitting diode (LED) source emitting either visible or invisible light and matched with a tracking scheme coupled to the vision magnification system 100 can also be used.

The IR pick-up camera 254 is designed to pick up IR energy from a light emitting diode (LED) 268 located at the end of the writing device 200, as shown in FIG. 7. The IR pick-up camera 254 is a wide-spectrum camera having a wide-angle lens 264 and an IR filter 266, as shown in FIG. 9. In one implementation a 940 nm bandpass filter is used to allow IR light through. The use of the wide-angle lens 264 is optional depending on camera lens and the field of view for which IR energy is examined. The larger the field of view the more disadvantageously the camera is sensitive to ambient IR energy. The photo-diode 258 recognizes IR presence emanating from the stationary work area 102 and emitted by LED 268. The signal from photo-diode 258 triggers the IR pick-up camera control circuit 256. The IR-pick-up camera 254 picks-up IR energy which is filtered through the IR filter 266 and which goes through the wide angle lens 264 prior to striking the IR pick-up camera 254. The IR filter 266 is selected to only allow desirable IR energy of certain wavelengths through and block most of ambient IR energy which are considered to be noise.

Other aspects of the writing device 200 are functional buttons, e.g., zoom button 280 and contrast button 282. While writing, the user can press the zoom button 280, and move the writing device 200 to right or left to cause changes in zoom levels. Once the button is released the writing device 200 returns to its original mode to be used for writing/drawing. Similarly, pressing the contrast button 282 and moving the writing device 200 to the right or left can cause changes in the contrast. Releasing the contrast button 282 returns the writing device 200 to its original mode for writing/drawing. Alternatively, a wheel (not shown) similar to the wheel 164 on the electronic pointing device 160 can be used to adjust the desired functionalities.

Activating buttons 280 and 282 cause LED 268 to blink. In one embodiment, LED 268 blinks with different frequencies to identify which button 280 or 282 has been pressed. In turn, photo diode 258 and IR pickup camera 254 can detect the frequency of blinking and movement of the writing instrument to determine which button has been pressed and the actions requested by the user. In another embodiment a change in the duty cycle can indicate which button has been pressed.

As mentioned above, the circuitry housing 114 moves in accordance with the movement of the electronic pointing device 160 or the writing device 200. Movement according to each of these two modes is described below. As the user moves the electronic pointing device 160, the processor 260 receives any one of encoded digital signals or analog signals, as described above, and determines the amount of motion in the X-direction 152. The processor 260 calculates the amount of movement in the X-direction subassembly 140 must make commensurate with the movement of the electronic pointing device 160. Although reference numerals in connection with FIGS. 2-3 are used to describe the movement of X and Y direction subassemblies, the same applies to the embodiment of FIGS. 4-6. As described above, the processor 260 can access a look-up table corresponding with the amount of time for which the X-motor 142 must be activated in order to achieve the correct amount of rotation. As mentioned above, a variety of motor control schemes, e.g., with feedback and with feedforward-only, can be used to control the X-motor 142. Furthermore, a variety of motors, e.g., DC, AC, or stepper motor, can be used to achieve the desired rotation. Thereby, the processor 260 calculates the amount of rotation that is needed by the X-motor 142 and either sends a representation of the needed rotation as a digital packet of information to a stepper motor implementation or DC or AC motor implementation with an encoder of the X-motor 142, or by activating a single I/O port for the required amount of time. The latter can be buffered and sent as a digital signal to a digital input port of the X-motor 142 which is equipped with accepting digital signals. Alternatively, the buffered version of the I/O signal from the processor 260 can be used to activate a relay, solid state relay, transistor, field effect transistor or a variety of other switches that are known to those skilled in the art. The switched output can then activate the X-motor 142. As is well known in the art, a flyback mechanism must also be used to dissipate the inductive energy of the motor to prevent damages to whatever switching scheme is implemented. The flyback mechanism can be integrated within the motor or must be used outside of the motor.

Additionally, the processor 260 has to be able to activate the X-motor 142 in forward and reverse directions. Depending on the implementations of the X-motor 142, e.g., DC, AC, or stepper, different techniques are used to achieve bi-directional movements by the X-motor 142. For example, a DC motor can be activated in a reverse direction by reverse-polarizing the armatures of the motor. Alternatively, a stepper motor can be zeroed at the middle of its digital range. For example, if a stepper motor's maximum range is 256 steps, i.e., 11111111, the middle of that range, i.e., 10000000, can be used to correspond to the center of the stationary work area 102. In this way, 128 steps are assigned for movement to the right from the center of the stationary work area and 128 steps are assigned for movement to the left of the center. Other methods, e.g., using gears, are known to those skilled in the art which are also available to achieve bi-directional rotation of the X-motor 142.

Once the motor activation mechanism, described above, has energized the X-motor 142, the X-motor shaft 154 begins to turn. This rotation causes X-pulley 144 (a) to turn. The X-belt 146, wound between X-pulleys 144 (a) and 144 (b), turns corresponding to the rotation of the X-motor shaft 154. The X-attachment 150 couples the X-belt 146 to the X-bracket 148, which causes the X-direction motion subassembly 140 to move horizontally in the X-direction 152.

As mentioned above, movement of the X-direction motion subassembly 140 in the X-direction 152 causes the circuit housing 114 to move in the X-direction 152. As mentioned previously, the circuit housing 114 houses main camera 250 and main camera control circuit 252. As the circuit housing 114 is moving in the X-direction 152 images captured by the main camera 250 and processed by the camera control circuit 252 is projected on to the monitor 106.

As the X-motor 142 is actuated, acceleration and deceleration of the motor 142 is controlled. A dampening effect is used to prevent or reduce the motion sickness experienced by users of image magnifications system. This is achieved by either starting the X-motor 142 with a reduced voltage, mechanically or hydraulically dampening the rotation of the X-motor shaft 154 by placing a dampening device between the X-motor 142 and X-pulley 144 (a), electronically dampening motor activation, time-spacing the steps in the stepper motor implementation to control the acceleration of the rotation or placing a large gear-ratio on the output of the X-motor 142 all of which cause a slowed start-up followed by a slowed termination of rotation. Other techniques known to those skilled in the art may also be used to control the acceleration/deceleration of the X-motor 142.

As the user moves the electronic pointing device 160 to the right, while periodically lifting the electronic pointing device 160 off a work surface and retracting the pointing device to the left followed by placing the pointing device back on the work surface, the main camera 250 follows the direction and pace of the movement of the electronic pointing device 160. That is, as the user slows or speeds up the movement of the electronic point device 160, the processor 260 controls the speed of X-motor 142 correspondingly, which directly translate to the pace of movement of the main camera 250.

The user can lock the motion of the main camera to travel in the X-direction 152 only. That is, as the user is moving the electronic pointing device 160 in an attempt to read written text, inadvertent movements of the electronic pointing device 160 in the Y-direction 116 are ignored. By using a combination of buttons 162 on the electronic pointing device 160, the user can program the processor 260 to only allow movement of the main camera 250 in the X-direction 152. In order to move to the next line of written material in this locked X-direction mode, the user presses a button 162 on the electronic pointing device 160 to cause the Y-direction motion subassembly 115 to move the main camera 250 in the Y-direction 116. The user trains the processor 260 to the amount of movement required in the Y-direction 116, which corresponds to the distance in the Y-direction required to advance one line, as well as the amount of return travel in the X-direction 152, which corresponds to left most column of the page.

Alternatively, the vision magnification system 100 can adaptively recognize the beginning and end of lines of text or writing and automatically advance in the Y-direction when the images captured from the main camera 250 and processed by the main camera control circuit 252 indicate arrival at the end of a line. To achieve this, white space near the end of a line can be used a triggering event for advancement of the Y-direction motion subassembly 115 in the Y-direction 116. Image recognition techniques required for this feature are well known to those skilled in the art. Alternatively, the user may select a scanning approach to cause the X-direction motion subassembly 140 to move the main camera 250 in the X-direction 152 at a constant speed, followed by advancing the Y-direction motion subassembly 115 in the Y-direction 116 when the main camera control circuit 252 or the processor 260 has recognized an end of a line event. The speed of scanning in the X-direction can be adjusted by turning the wheel 164 on the electronic pointing device 160.

Movement of the writing device also causes the Y-direction motion subassembly 115 and the X-direction motion subassembly 140 to move. As described above, presence of IR energy, somewhere in the space defined by the stationary work area 102, is recognized by the photo-diode 258 which transmits a signal which is used to trigger the IR pick-up camera control circuit 256. The IR pick-up camera 254, receives filtered spectrum of light matching the LED 268 mounted on the writing instrument 200. The IR pick-up camera control circuit 256 communicates information on the position of the LED 268, which corresponds to the position of the writing device 200, to the processor 260. In turn, the processor calculates the position of the LED 268 and causes the Y-direction motion subassembly 115 and the X-direction motion subassembly 140 to move to the calculated position. Therefore, as the user moves the writing device 200 in the Y-direction 116 or the X-direction 152, the main camera 250 moves along with the writing device 200. Therefore, the magnified image 104 displays the writing device 200 in approximately the center of the monitor 106 as the user moves the writing device 200.

In order to accommodate various inputs, e.g., multimedia inputs from different sources, the vision magnification system 100 includes a picture-in-picture (PIP) capability. The PIP capability is shown in FIG. 2. The PIP window 300 is shown in the upper left hand corner of the monitor 106, while the magnified image 104 takes up the remaining portion of the monitor 106. The content of the PIP window 300 can be from any of the multimedia sources connected to the vision magnification system 100. These are auxiliary video inputs via composite video or multi-channel S-video inputs, VGA input from a computer, and stereo/mono inputs. A volume control 320 is provided for adjusting volume of the auxiliary audio input. The contents of the PIP window 300 can be switched with the magnified image 104, so that the PIP window 300 displays the magnified image while the remaining portion of the monitor displays the auxiliary input.

One use for the auxiliary input can be to display images from the surroundings of the system magnification system 100. For example, in a classroom setting, the user may need to view the content of a screen shown in the classroom as well as viewing the magnified images of the material placed on the stationary work area 102. An auxiliary video camera can be used in this instance to zoom in on the instructor or on the classroom screen and show the corresponding images in the PIP window 300.

Additionally, the user can control the auxiliary camera functions similar to the way the main camera 250 is controlled so as to move the camera, focus, change contrast, and zoom in on the objects located in the surroundings of the user. By switching the content of the PIP window 300 to the main window, the user can control the position of the auxiliary video camera by rotating the camera in a housing, zooming on to the object, focusing on the object, and performing other common task known to those skilled in the art. The user switches between the windows by pressing button 162 on the electronic pointing device 160. The movement of the auxiliary camera is achieved in a similar manner as the main camera 250. That is, the user manipulates the electronic pointing device 160 by moving the pointing device to cause movement of the auxiliary camera in the housing; pressing on the buttons 162 to initiate functions described above, and to manipulate the wheel 164 to further initiate video camera functions. Since the electronic pointing device 160 is used for both main camera 250 and auxiliary camera manipulations, in the case where the PIP window 300 and the magnified image 104 window are displaying images of both the main camera 250 and the auxiliary camera, the camera which corresponds to the PIP window 300 cannot be manipulated. That is, only the camera corresponding to the magnified image 104 window is manipulatable. If the user desires to change settings of a camera which is displaying images in the PIP window 300, the user must first switch the image of that camera to the magnified image 104 window and then using the electronic pointing device 160 change the settings of that camera.

The vision magnification system 100 can be accessed by a remote station via the World Wide Web by using a standard connection known to those skilled in the art. By accessing the processor 260, remotely, technicians can debug the electronics on the vision magnification system 100, download software updates, monitor usage, and provide update warnings to the users.

The image magnification system in accordance with the current teachings is also capable of sending a digital stream recognizable by a personal computer for recordation purposes. In one application, the image magnification system can be used a training tool. A digital stream of data, e.g., Moving Picture Experts Group (MPEG), is generated by circuit 120 as the user manipulates the cameras in the X and Y directions. Also, any auxiliary input that is displayed on the monitor can also be added to a digital file, e.g., an MPEG file. The digital file can be exported to a personal computer where it can be stored for repeat viewing. In this way, any image that the user would have seen during a session can be stored to a digital file and transferred to a computer. Conversely, utilizing sufficiently sophisticated processors, digital files can also be read by the image magnification system and displayed on the monitor. The image restored from the digital files can be manipulated in the same manner described above in connection with images from the work area.

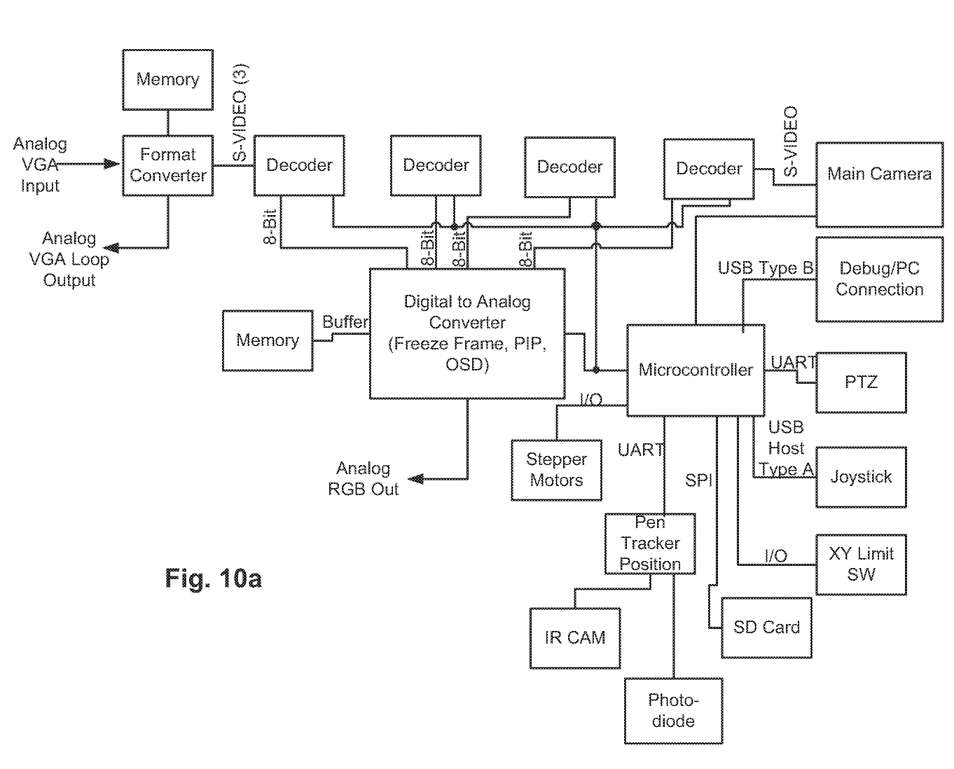

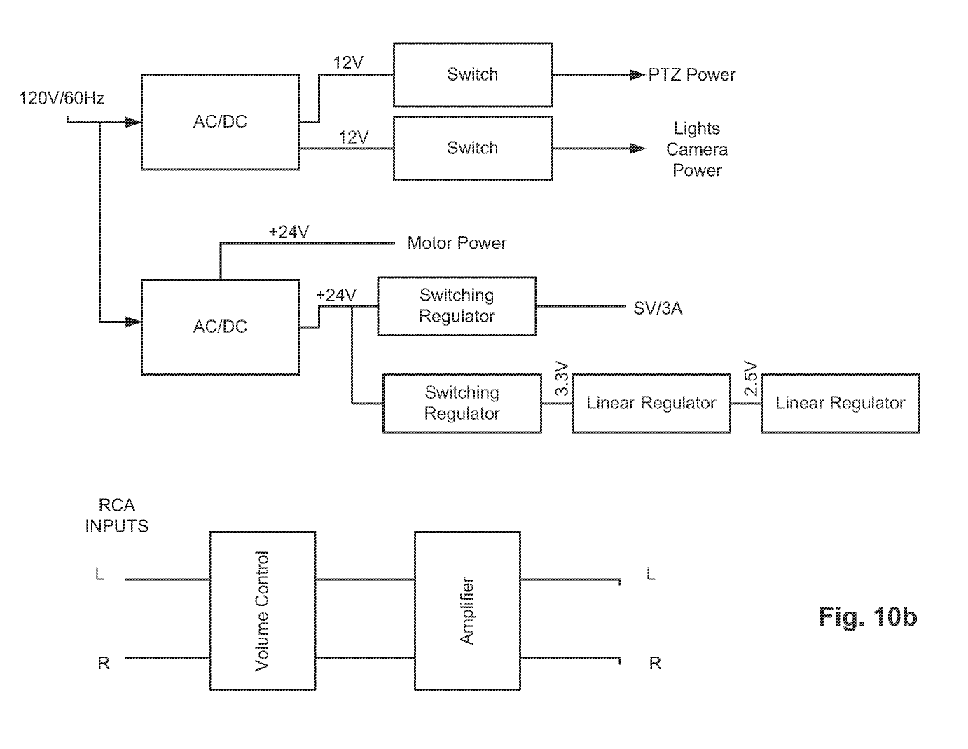

Referring now to FIGS. 10a and 10b, schematic views are provided which show the interactions between various hardware blocks. As noted in FIG. 10a, there are several multimedia input channels, several interconnecting bus protocols, and several memory blocks which interface with processors. As shown in FIG. 10b, AC-DC converters and DC-DC regulators are provided with several voltage outputs that are used for various electrical and electronic devices.

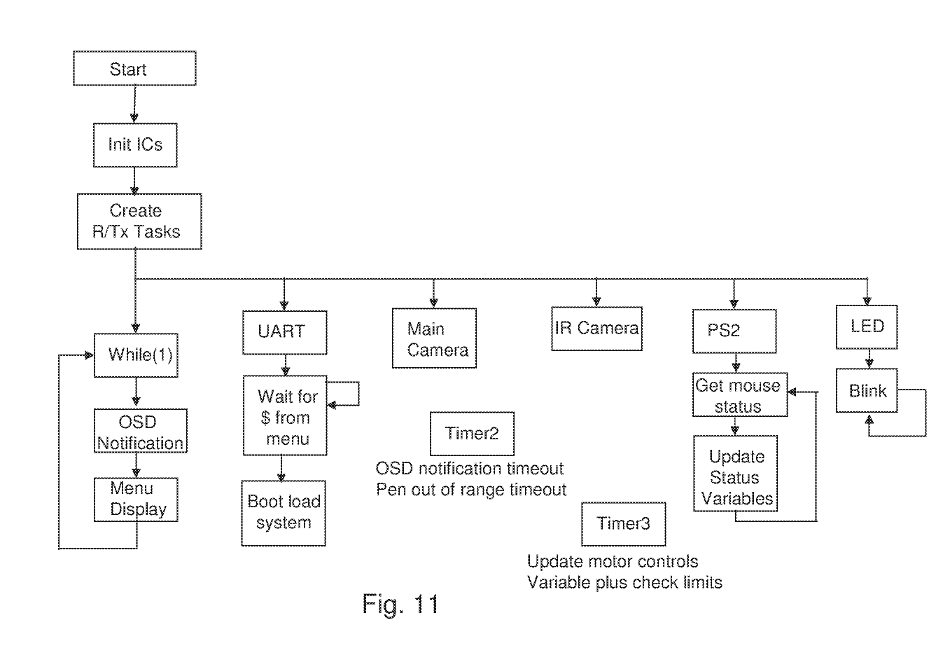

Referring to FIG. 11, a software flowchart is provided. A loop-based algorithm can be implemented. Alternatively an interrupt-based algorithm with a priority scheme whereby interrupt service routines are executed based on their priority, as known to those skilled in the art, can also be implemented. Whatever structure is chosen, i.e., looping or interrupt-based, certain events are monitored or allowed to trigger the software to taken actions. These events are OSD, UART communication, main camera, IR camera, mouse communication, and LED communication.

While exemplary embodiments incorporating the principles of the present invention have been disclosed hereinabove, the present invention is not limited to the disclosed embodiments. Instead, this application is intended to cover any variations, uses, or adaptations of the invention using its general principles. Further, this application is intended to cover such departures from the present disclosure as come within known or customary practice in the art to which this invention pertains and which fall within the limits of the appended claims.

We claim:

1. A vision magnification system to provide a magnified image of an object for viewing by a user, comprising:
a fixed work area, to support the object;
a first camera, to provide an image of at least a portion of the object;
a camera movement control system taking inputs from the user and thereby controlling the movement of the first camera; and
a drive system coupled to the first camera and to the camera movement control system to move the first camera in at least one direction.

2. The vision magnification system of claim 1, wherein the drive system includes a movable support to support the first camera in spaced relation with the fixed work area and to move the first camera in a first linear direction and a second linear direction with respect to the fixed work area, the second linear direction being substantially perpendicular to the first linear direction.

3. The vision magnification system of claim 2, wherein the drive system includes a first motor coupled to the movable support, the first motor moving the first camera in the first linear direction.

4. The vision magnification system of claim 3, wherein the drive system includes a second motor coupled to the movable support, the second motor moving the first camera in the second linear direction.

5. The vision magnification system of claim 4 further comprising a first translation device, coupled to the first motor, to translate rotational motion of the first motor to a linear motion of the movable support along the first linear direction.

6. The vision magnification system of claim 5 further comprising a second translation device, coupled to the second motor, to translate rotation motion of the second motor to a linear motion of the movable support along the second linear direction.

7. The vision magnification system of claim 6, wherein at least one of the first and second translation devices includes a belt.

8. The vision magnification system of claim 7, wherein at least one of the first and second translation devices includes a solid link between at least one of the first and second motors and the movable support.

9. The vision magnification system of claim 9, wherein the solid link is an all-thread elongated screw.

10. The vision magnification system of claim 1, further comprising a monitor electronically coupled to the first camera to display the image provided by the first camera.

11. The vision magnification system of claim 10, wherein the camera movement control system comprises:
a processor;
a moveable control device, electronically coupled to the processor, wherein the processor controls the movement of the drive system in response to the movement of the control device.

12. The vision magnification system of claim 11, wherein the control device comprises a pointing device to generate a signal representative of movement of the user.

13. The vision magnification system of claim 12, wherein the pointing device generates a signal to control at least one of contrast of the monitor, selection of written text displayed on the monitor, magnification of the monitor, brightness of the monitor, and triggering of an on-screen display on the monitor.

14. The vision magnification system of claim 13, wherein the processor detects an end of a line of text of the object and a space between lines of text of the object.

15. The vision magnification system of claim 14, wherein the control device includes a light source to illuminate the object.

16. The vision magnification system of claim 15, further comprising an infrared light source disposed on the control device.

17. The vision magnification system of claim 16, further comprising:
an infrared filter disposed on the moveable support, wherein only infrared energy is allowed to propagate through the filter; and
a second camera disposed on the moveable support and proximate to the infrared filter, the second camera electronically communicating with the processor, thereby detecting a location of the infrared light source.

18. The vision magnification system of claim 17, wherein the control device is a writing instrument, thereby allowing the user to write within the fixed work area.

19. The vision magnification system of claim 18, wherein the processor controls the drive system and thereby the movement of the first camera according to the position of the control device.

20. The vision magnification system of claim 19, wherein the processor detects when the control device has reached the end of a line of text and thereby controls the drive system to move to the beginning of the next line of text.

21. The vision magnification system of claim 11, wherein the processor controls the drive system according to the movement of the control device based on a smoothing algorithm, thereby adjusting acceleration and deceleration of the first camera.

22. A vision magnification system to provide an image of an object for viewing by a user, comprising:
a first camera directed at an object;
a monitor displaying an image of at least part of the object;
a drive system, coupled to the camera, to move the camera in a first direction and a second direction;
a processor, coupled to the drive system, to control movement of the first camera; and
a control device, coupled to the processor, wherein the control device communicates with the processor and thereby controls the movement of the first camera in the first and second directions.

23. The image magnification system of claim 22, further comprising at least one selector disposed on the control device, wherein the at least one selector controls a plurality of image parameters.

24. The image magnification system of claim 23, wherein the plurality of image parameters include contrast of the monitor, selection of written text displayed on the monitor, magnification of the monitor, brightness of the monitor, and triggering of an on-screen display on the monitor.

25. The image magnification system of claim 22, wherein the control device is a writing instrument.

26. The image magnification system of claim 25, further comprising:
an infrared light source disposed on the control device;
an infrared filter disposed proximate to the first camera, wherein only infrared energy is allowed to propagate through the filter; and
a second camera disposed proximate to the infrared filter, the second camera electronically communicating with the processor, thereby detecting a location of the infrared light source.

27. The vision magnification system of claim 22, wherein the processor detects an end of a line of text of the object and a space between lines of text of the object.

28. The vision magnification system of claim 27, wherein the processor detects when the control device has reached the end of a line of text and thereby controls the drive system to move to the beginning of the next line of text.

29. The vision magnification system of claim 22, wherein the processor controls the drive system according to the movement of the control device based on a smoothing algorithm, thereby adjusting acceleration and deceleration of the first camera.
